(19) United States
(12) Patent Application Publication
(10) Pub. No.: US 2026/0019740 A1
(43) Pub. Date: Jan. 15, 2026

(54) VIBRATION ISOLATION FOOT FOR AUDIO EQUIPMENT

(71) Applicant: Yat Hong WONG, Tin Shui Wai (HK)

(72) Inventor: Yat Hong WONG, Tin Shui Wai (HK)

(21) Appl. No.: 18/985,524

(22) Filed: Dec. 18, 2024

(30) Foreign Application Priority Data
Jul. 9, 2024 (HK) 32024093893.8

(51) Int. Cl. H04R 1/28

(52) U.S. Cl. CPC H04R 1/2892; H04R 1/2876

(57) ABSTRACT

The present invention provides a vibration isolation foot for audio equipment. The vibration isolation foot for audio equipment is configured to be fixedly connected to a bottom of the audio equipment, and includes a vibration isolation foot body. An action chamber is provided in the vibration isolation foot body, and the action chamber is filled with damping oil and at least one ceramic ball. When the audio equipment is subjected to vibrations, the vibrations are transmitted to the vibration isolation foot body, causing the at least one ceramic ball to move within the action chamber and create ripples in the damping oil, and the ripples absorb and consume vibrational energy, resulting in vibration isolation. The vibration isolation foot for audio equipment improves the poor vibration absorption performance of existing vibration isolation feet and addresses the issue of wobbling which can negatively affect user experience.

### TECHNICAL FIELD

The present invention relates to the field of vibration isolation technology for audio equipment, in particular to a vibration isolation foot for audio equipment.

### BACKGROUND

Vibrations are widely recognized as a significant threat to audio equipment. Excessive vibrations can harm sound quality, resulting in diminished resolution, reduced transparency, and even heightened noise levels. Additionally, vibrations can affect the performance and longevity of components. As a result, vibration isolation feet are commonly employed in audio equipment to isolate vibrations. The vibration isolation feet help block low-frequency waves that travel through the ground, preventing resonance between the low-frequency waves and the audio equipment, while also shifting the resonance point of the audio equipment to adjust its resonant coefficient, thus avoiding interference from the low-frequency waves through the air. However, most existing audio equipment uses spring-based vibration isolation feet, which rely on the elasticity of springs to absorb and isolate vibrations. This structure often fails to provide sufficient absorption, leading to a decline in equipment performance. Additionally, when spring-based vibration isolation feet are connected to audio equipment, the audio equipment can become unstable and prone to wobbling, which can negatively affect user experience.

### SUMMARY

The present invention discloses a vibration isolation foot for audio equipment, aimed at improving the poor vibration absorption performance of existing vibration isolation feet and addressing the issue of wobbling which can negatively affect user experience.

The present invention adopts the following scheme.

A vibration isolation foot for audio equipment, configured to be fixedly connected to a bottom of the audio equipment, includes a vibration isolation foot body. An action chamber is provided in the vibration isolation foot body, and the action chamber is filled with damping oil and at least one ceramic ball. When the audio equipment is subjected to vibrations, the vibrations are transmitted to the vibration isolation foot body, causing the at least one ceramic ball to move within the action chamber and create ripples in the damping oil, and the ripples absorb and consume vibrational energy, resulting in vibration isolation.

Preferably, the vibration isolation foot body includes an upper shell and a lower shell, the upper shell is provided with a connecting part extending downward, a receiving hole is provided in an axial direction of the connecting part, the lower shell is provided with an assembly hole, and the connecting part is inserted into the assembly hole for restraining, allowing the receiving hole to cooperate with an inner wall of the assembly hole to form the action chamber.

Preferably, the connecting part is columnar, a limiting groove is formed around an outer wall of the connecting part, the lower shell is provided with a mounting hole penetrating from a side wall to the assembly hole, the mounting hole is configured to be connected to a fastener, and the fastener extends into the limiting groove, ensuring that the upper shell is axially constrained.

Preferably, the mounting hole is a stepped hole including a plain section and a threaded section, the plain section is arranged close to an outer wall of the lower shell and is provided with a steel ball for sealing the mounting hole, and the threaded section is configured to be connected to the fastener.

Preferably, a decorative groove is provided in the outer wall of the lower shell in a circumferential direction thereof, and a width of the decorative groove is smaller than a diameter of the mounting hole.

Preferably, an end, away from the connecting part, of the upper shell is provided with a threaded hole, and the threaded hole is connected to the audio equipment through a threaded connecting piece.

Preferably, an end, facing the receiving hole, of the connecting part is provided with a chamfer.

Preferably, the ceramic ball has a diameter of 8 mm.

Preferably, the ceramic ball is made of silicon nitride (Si₃N₄).

Preferably, the vibration isolation foot body is made of stainless steel.

By adopting the above technical solution, the present invention can achieve the following technical effects.
1. In this application, when the audio equipment is subjected to vibrations, the vibrations are transmitted to the ceramic balls, causing the at least one ceramic ball to move within the action chamber and create ripples in the damping oil. The ripples absorb vibrational energy, and as they dissipate, they effectively convert the vibrational energy into heat and other forms of energy that do not affect the audio equipment.
2. By using the ceramic ball with high hardness, low thermal expansion, excellent wear resistance, and outstanding vibration damping characteristics, along with the damping oil that offers high thermal stability and consistent damping properties over a wide temperature range, a good damping effect can be achieved within the action chamber, thereby providing sufficient vibration absorption capability. Additionally, the action chamber may be filled with multiple ceramic balls, and the mutual friction and collisions between the ceramic balls during vibration can enhance the damping effect, achieving multi-level vibration reduction.
3. The vibration isolation foot body does not require a spring structure, allowing the audio equipment to remain in a stable assembly state and preventing the audio equipment from wobbling relative to the vibration isolation foot, making it convenient for users. Specifically, the vibration isolation foot body may be fixedly connected to the audio equipment using threaded connecting pieces.

### BRIEF DESCRIPTION OF DRAWINGS

In order to explain the technical solutions of implementations of the present invention more clearly, the accompanying drawings to be used in the illustration of the implementations are briefly described below. It should be understood that the following accompanying drawings only show some embodiments of the present invention and therefore should not be considered limiting of its scope. For those of ordinary skill in the art, other relevant drawings can be derived on the basis of these drawings without any inventive effort.

FIGS. 1-3 are schematic diagrams of an embodiment of the present invention at different viewing angles;

FIG. 4 is a cross-sectional view of an embodiment of the present invention;

FIGS. 5 and 6 are schematic diagrams of a lower shell according to an embodiment of the present invention at different viewing angles;

FIGS. 7 and 8 are schematic diagrams of an upper shell according to an embodiment of the present invention at different viewing angles; and

FIG. 9 is an exploded view of an embodiment of the present invention.

### REFERENCE NUMERALS

1—Vibration isolation foot body; 11—Action chamber; 12—Upper shell; 121—Connecting part; 122—Receiving hole; 123—Limiting groove; 124—Chamfer; 125—Threaded hole; 13—Lower shell; 131—Assembly hole; 132—Mounting hole; 133—Decorative groove; 14—Fastener; and 15—Steel ball;
2—Ceramic ball;
3—Damping oil; and
4—Threaded connecting piece.

### DETAILED DESCRIPTION

In order to make the objectives, technical solutions and advantages of the implementations of the present invention clearer, the technical solutions in the implementations of the present invention are clearly and completely described in the following with reference to the accompanying drawings in the implementations of the present invention. It is obvious that the described implementations are only some of the implementations instead of all the implementations of the present invention. All other implementations obtained by those of ordinary skill in the art based on the implementations of the present invention without inventive effort are within the scope of the present invention. Therefore, the following detailed description of the implementations of the present invention in the accompanying drawings is not intended to limit the scope of protection of the present invention, but merely represents selected implementations of the present invention. All other implementations obtained by those of ordinary skill in the art based on the implementations of the present invention without inventive effort are within the scope of the present invention.

### Embodiment

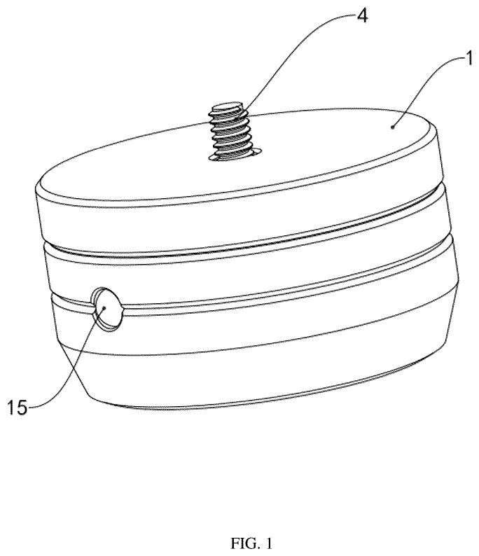

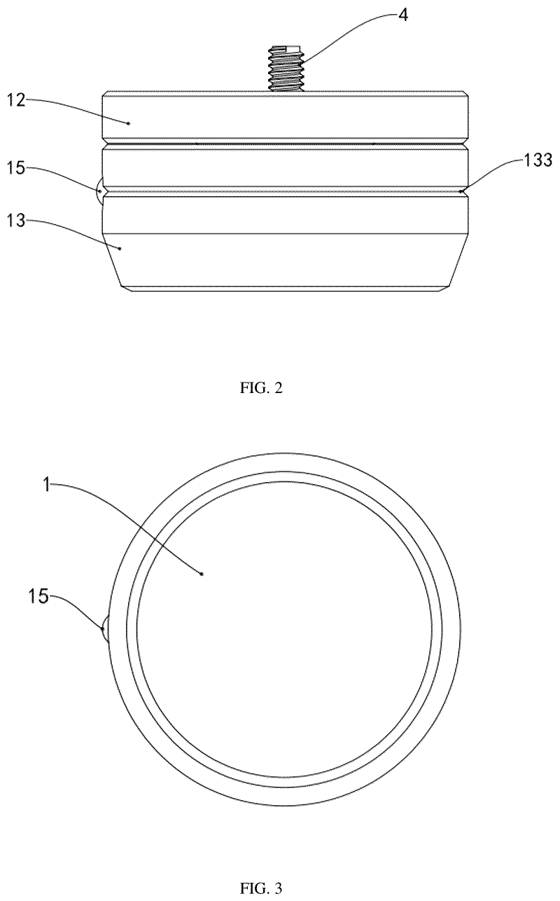

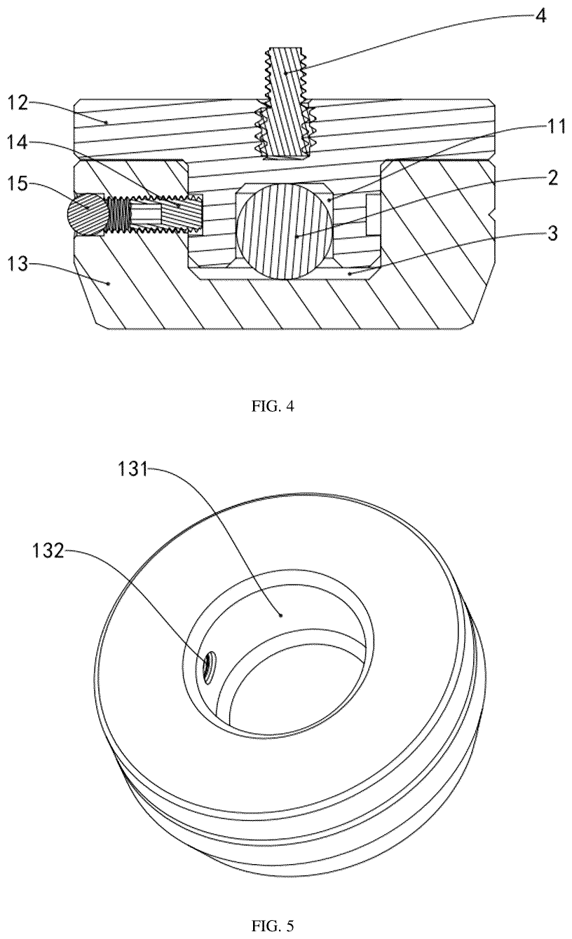

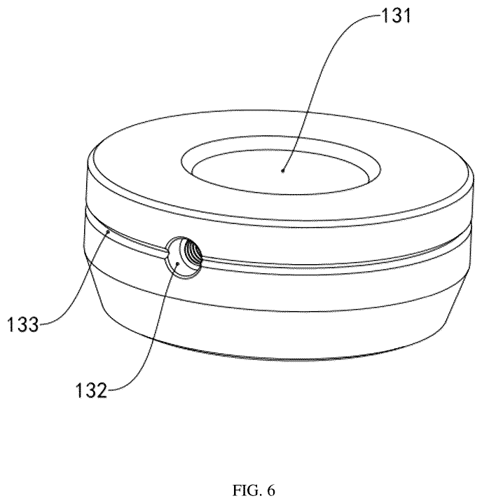

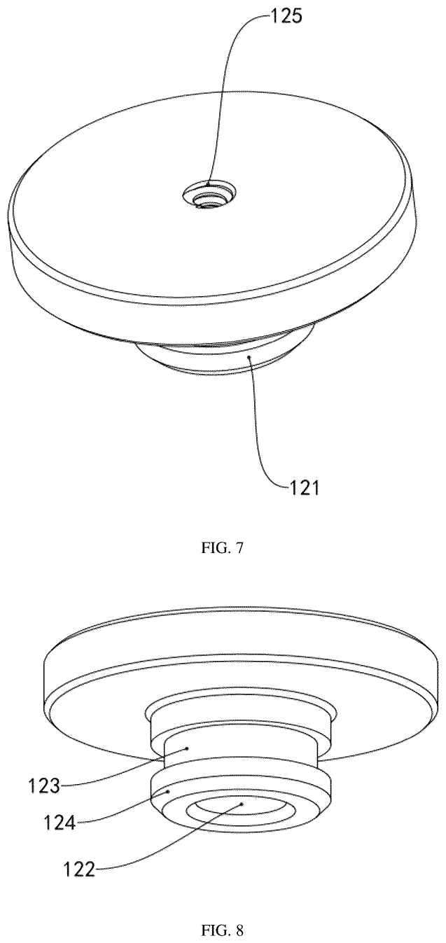

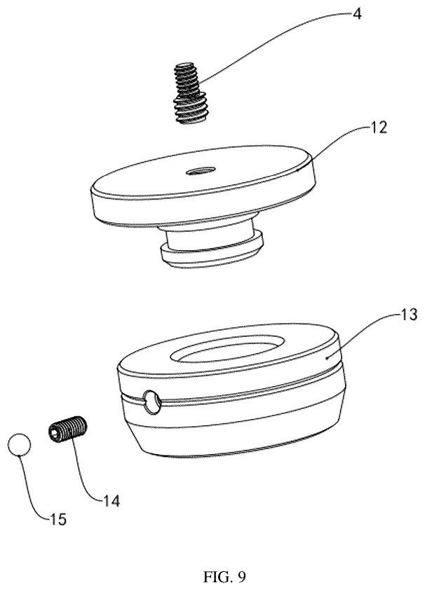

With reference to FIGS. 1-9, this embodiment provides a vibration isolation foot for audio equipment configured to be fixedly connected to a bottom of the audio equipment, which includes a vibration isolation foot body 1. An action chamber 11 is provided in the vibration isolation foot body 1, and the action chamber 11 is filled with damping oil 3 and at least one ceramic ball 2. When the audio equipment is subjected to vibrations, the vibrations are transmitted to the vibration isolation foot body 1, causing the ceramic ball(s) 2 to move within the action chamber 11 and create ripples in the damping oil 3, and the ripples absorb and consume vibrational energy, resulting in vibration isolation.

For example, a ceramic ball 2 having a diameter of 8 mm is arranged in the action chamber 11, and the material of the ceramic ball 2 is preferably silicon nitride (Si₃N₄) or equivalent high-hardness and low-density ceramic. The damping oil 3 is preferably silicone oil having a viscosity of 15,000 cSt at 25° C. By using the ceramic ball 2 with high hardness, low thermal expansion, excellent wear resistance, and outstanding vibration damping characteristics, along with the damping oil 3 that offers high thermal stability and consistent damping properties over a wide temperature range, a good damping effect can be achieved within the action chamber 11, thereby providing sufficient vibration absorption capability. In other implementations, the action chamber 11 may be filled with multiple ceramic balls 2, and the mutual friction and collisions between the ceramic balls 2 during vibration can enhance the damping effect, achieving multi-level vibration reduction.

It should be noted that when the ceramic ball 2 moves and creates ripples in the damping oil 3, the internal friction of the damping oil 3 resists this motion, resulting in very small ripple amplitudes. Oils with higher viscosity exhibit greater internal friction, meaning they can absorb and dissipate more vibrational energy in the form of heat. At the same time, the viscosity of the oil also determines the rate at which the ripples decay or diminish. Oils with higher viscosity dissipate ripples more quickly, allowing the ripples generated by the vibrating ceramic ball 2 to be dampened faster, with vibrational energy quickly converted to heat and dissipated in the liquid, thus preventing it from being transmitted to the audio equipment. Additionally, viscosity is related to the oil's capacity to process and dissipate thermal energy. Oils with higher viscosity usually exhibit better thermal stability, allowing them to absorb more energy without significantly altering their damping characteristics. This ensures consistent performance even under continuous or high-energy vibration conditions. In summary, oils with higher viscosity are more effective at suppressing low-frequency vibrations because they provide greater resistance to slowly moving ripples, making them suitable for applications requiring low-frequency isolation. Medium-viscosity oils, on the other hand, are effective across a wider frequency range, absorbing energy without overly suppressing potentially important high-frequency vibrations in the equipment.

In a preferable embodiment, the vibration isolation foot body 1 includes an upper shell 12 and a lower shell 13, the upper shell 12 is provided with a connecting part 121 extending downward, a receiving hole 122 is provided in an axial direction of the connecting part 121, the lower shell 13 is provided with an assembly hole 131, and the connecting part 121 is inserted into the assembly hole 131 for restraining, allowing the receiving hole 122 to cooperate with an inner wall of the assembly hole 131 to form the action chamber 11. Here, the size of the action chamber 11 is sufficient to permit the movement of the ceramic ball 2 and the generation of ripples in the damping oil 3. Preferably, the vibration isolation foot body 1 is made of stainless steel or other durable, non-reactive materials. For example, both the upper shell 12 and the lower shell 13 are made of stainless steel to avoid reaction between the action chamber 11 and the damping oil 3 and ensure the damping effect of the damping oil 3.

Further, the connecting part 121 is columnar, a limiting groove 123 is formed around an outer wall of the connecting part 121, the lower shell 13 is provided with a mounting hole 132 penetrating from a side wall to the assembly hole 131, the mounting hole 132 is configured to be connected to a fastener 14, and the fastener 14 extends into the limiting groove 123, ensuring that the upper shell 12 is axially constrained. In an embodiment, the mounting hole 132 is a stepped hole including a plain section and a threaded section, the plain section is arranged close to an outer wall of the lower shell 13 and is provided with a steel ball 15 for sealing the mounting hole 132, and the threaded section is configured to be connected to the fastener 14. For example, the aperture size of the plain section is larger than that of the threaded section, and the fastener 14 is an internal hexagon screw. During installation, the connecting part 121 of the upper shell 12 is first aligned with and inserted into the assembly hole 131 of the lower shell 13; then, the internal hexagon screw is tightened into the threaded section through the mounting hole 132 in the side wall of the lower shell 13; simultaneously, the internal hexagon screw extends into the limiting groove 123 and presses against a wall surface of the limiting groove 123, ensuring that the upper shell 12 is fixed in position. Finally, the steel ball 15 is inserted into the plain section of the mounting hole 132 to seal the mounting hole 132 and prevent the damping oil 3 from leaking. As an improvement, an end, facing the receiving hole 122, of the connecting part 121 is provided with a chamfer 124 to facilitate the placement of the connecting part 121 into the receiving hole 122, making installation easier.

Based on the above embodiment, in an optional embodiment of the present invention, a decorative groove 133 is provided in the outer wall of the lower shell 13 in a circumferential direction thereof, and the width of the decorative groove 133 is smaller than the diameter of the mounting hole 132. In an implementation, the decorative groove 133 extends through the mounting hole 132, with the colour of the decorative groove 133 set to be different from that of the outer wall of the lower shell 13, which enhances the aesthetic appeal of the vibration isolation foot. In another implementation, the thickness of the upper shell 12 that is visible above the lower shell 13 is made equal to the height from the decorative groove 133 to a top surface of the lower shell 13, enhancing the overall aesthetic unity of the vibration isolation foot. This is not intended to impose specific limitations.

In other embodiments, an end, away from the connecting part 121, of the upper shell 12 is provided with a threaded hole 125, and the threaded hole 125 is connected to the audio equipment through a threaded connecting piece 4. The threaded connecting piece 4 may be configured with a big end and a small end, with the big end intended for connection to the threaded hole 125 and the small end for connection to the audio equipment. In the installation process, the big end may be screwed into the threaded hole 125 first, and then the small end is inserted into the audio equipment, facilitating easy installation. Additionally, by means of fixed connection through the threaded connecting piece 4, the audio equipment can maintain a stable assembly state, preventing any wobbling relative to the vibration isolation foot, making it convenient for users.

The above description represents only the preferred implementations of the present invention. The scope of protection of the present invention is not limited to the aforementioned embodiments, and all technical solutions that adhere to the principles of the present invention fall within the scope of protection of the present invention.

1. A vibration isolation foot for audio equipment, configured to be fixedly connected to a bottom of the audio equipment, comprising a vibration isolation foot body, wherein an action chamber is provided in the vibration isolation foot body, and the action chamber is filled with damping oil and at least one ceramic ball; and when the audio equipment is subjected to vibrations, the vibrations are transmitted to the vibration isolation foot body, causing the at least one ceramic ball to move within the action chamber and create ripples in the damping oil, and the ripples absorb and consume vibrational energy, resulting in vibration isolation.

2. The vibration isolation foot for audio equipment of claim 1, wherein the vibration isolation foot body comprises an upper shell and a lower shell, the upper shell is provided with a connecting part extending downward, a receiving hole is provided in an axial direction of the connecting part, the lower shell is provided with an assembly hole, and the connecting part is inserted into the assembly hole for restraining, allowing the receiving hole to cooperate with an inner wall of the assembly hole to form the action chamber.

3. The vibration isolation foot for audio equipment of claim 2, wherein the connecting part is columnar, a limiting groove is formed around an outer wall of the connecting part, the lower shell is provided with a mounting hole penetrating from a side wall to the assembly hole, the mounting hole is configured to be connected to a fastener, and the fastener extends into the limiting groove, ensuring that the upper shell is axially constrained.

4. The vibration isolation foot for audio equipment of claim 3, wherein the mounting hole is a stepped hole comprising a plain section and a threaded section, the plain section is arranged close to an outer wall of the lower shell and is provided with a steel ball for sealing the mounting hole, and the threaded section is configured to be connected to the fastener.

5. The vibration isolation foot for audio equipment of claim 4, wherein a decorative groove is provided in the outer wall of the lower shell in a circumferential direction thereof, and a width of the decorative groove is smaller than a diameter of the mounting hole.

6. The vibration isolation foot for audio equipment of claim 2, wherein an end, away from the connecting part, of the upper shell is provided with a threaded hole, and the threaded hole is connected to the audio equipment through a threaded connecting piece.

7. The vibration isolation foot for audio equipment of claim 2, wherein an end, facing the receiving hole, of the connecting part is provided with a chamfer.

8. The vibration isolation foot for audio equipment of claim 1, wherein the ceramic ball has a diameter of 8 mm.

9. The vibration isolation foot for audio equipment of claim 1, wherein the ceramic ball is made of silicon nitride (Si₃N₄).

10. The vibration isolation foot for audio equipment of claim 1, wherein the vibration isolation foot body is made of stainless steel.
